(19) United States
(12) Patent Application Publication
(10) Pub. No.: US 2007/0076977 A1
(43) Pub. Date: Apr. 5, 2007

(54) Method for calibrating camera parameters

(76) Inventors: Kuan-Wen Chen, Yilan City (TW); Yi-Ping Hung, Sijhih City (TW)

Correspondence Address: LIN & ASSOCIATES INTELLECTUAL PROPERTY, P.O. BOX 2339, SARATOGA, CA, 95070-0339, US

(21) Appl. No.: 11/243,600

(22) Filed: Oct. 5, 2005

(51) Int. Cl. G06K 9/36

(52) U.S. Cl. 382/276

(57) ABSTRACT

A method for calibrating camera parameters is disclosed, which is carried out on the basis of a moving calibration object subject to the influence of gravity. The method is carried out by causing the calibration object to move along a parabolic trajectory under the influence of gravity, taking pictures of the calibration object that moves along the trajectory with a camera at a preset shutter speed to obtain a plurality of calibration image with the calibration object at different positions and times, and based on the coordinates of the calibration images and the picturing times, estimating homography between an image plane and a trajectory plane, and then using the constraints provided by the homography to obtain intrinsic and extrinsic parameters of the camera.

### BACKGROUND OF THE INVENTION

1. Field of the Invention

The present invention relates generally to a method for calibrating parameters of cameras for camera networks, and in particular to a method for calibrating camera parameters based on a trajectory of an object induced by gravity of the object.

2. The Related Art

In a multi-camera based visual surveillance system, theoretically, a fixed geometric relationship is present between a global coordinate system and a camera coordinate system for each camera, provided the camera is fixed in spatial position. Camera calibration is carried out on the basis of the fixed geometric relationship, especially the global coordinates of each camera, image coordinates of an image taken by the camera, as well as the transformation between the image coordinates and associated global coordinates of an object photographed by the camera. Parameters of the camera may then be calibrated for precisely positioning a target taking activities in a give area.

The camera parameter for a networked camera includes intrinsic parameters, which define relationship between the camera's coordinates and image coordinates of the image taken by the camera, such as camera center and camera focus, and extrinsic parameters, which define the global coordinates of the camera, including orientation and position of the camera. Thus, an image taken by a particular network camera can be identified by using both the intrinsic and extrinsic parameters of the camera. Calibration of the extrinsic parameters of cameras in a camera network allows for transformation of camera coordinates of an object among different cameras. In other words, an image taken by one camera can be precisely located in the camera coordinate system of another camera.

Mathematic relationship between the intrinsic and extrinsic parameters for a camera is formulated as follows. The notations employed in the following formulations are given first. The image coordinates of an arbitrary point “m” in the image coordinate is represented as m=[u,v]^{T} and a corresponding point “M” in the 3D space has coordinates denoted by M=[X,Y,Z]^{T}. Homogenous coordinates augmented vectors, formed by adding “1” to the original vectors, are \tilde{m}=[x,y,1]^{T} and \tilde{M}=[X,Y,Z,1]^{T} for matrixes m and M, respectively. The relationship between the homogenous matrixes is illustrated in equation (1) as follows.
s\tilde{m}=A[R|T]\tilde{M} (1)
where s is an arbitrary scale factor, [R|T] represents the extrinsic parameters with R and T respectively denoting rotation and displacement of the camera, and

$$A = [ \begin{matrix}α & γ & {u}_{0} \\ 0 & β & {v}_{0} \\ 0 & 0 & 1\end{matrix} ] ,$$

which represents the intrinsic parameter matrix of the camera, wherein (u₀, v₀) are the coordinates of the principal point, α and β define the scale factors in image u and v axes, and γ describes the skewness of the two axes.

Based on equation (1), the coordinates of an object in the global coordinate system and the image coordinate can be transformed, which will be further described hereinafter, with the abbreviation A^{-T} represents both (A⁻¹)^{T} and (A^{T})⁻¹.

When a camera is used to take pictures of a calibration object, a plane, and without loss of generality, we assume the model plane has Z-axis coordinate equal to zero in the global coordinate system, and equation (1) can be rewritten as follows:

$$s [ \begin{matrix}x \\ y \\ 1\end{matrix} ] = A [ \begin{matrix}{r}_{1} & {r}_{2} & {r}_{3} & t\end{matrix} ] [ \begin{matrix}X \\ Y \\ 0 \\ 1\end{matrix} ] = A [ \begin{matrix}{r}_{1} & {r}_{2} & t\end{matrix} ] [ \begin{matrix}X \\ Y \\ 1\end{matrix} ] \qquad ( 2 )$$

where rᵢ denotes the ith column of the rotation matrix R. Equation (2) can be further rewritten as
s\tilde{m}=H\tilde{M} (3)
where H=[r₁ r₂ t], which is a 3×3 homography matrix, indicating the relationship between M and m, the coordinates of the calibration object in the global coordinate system and the image coordinate, respectively.

By denoting H=[h₁ h₂ h₃], and since H=[r₁ r₂ t], the following equation is derived:
[h₁ h₂ h₃]=λA[r₁ r₂ t] (4)
where λ is an arbitrary scalar. Due to the knowledge that r₁ and r₂ are orthonormal, the followings are obtained:
∥r₁∥=∥r₂∥ and r₁·r₂=0
from which the following two constraints are derived:
h₁^{T}A^{-T}A⁻¹h₁=h₂^{T}A^{-T}A⁻¹h₂ (5)
and
h₁^{T}A^{-T}A⁻¹h₂=0 (6)

A new matrix B is defined as follows:

$$\begin{matrix}B = {A}^{- T} {A}^{- 1} \\ = [ \begin{matrix}{B}_{11} & {B}_{21} & {B}_{31} \\ {B}_{12} & {B}_{22} & {B}_{32} \\ {B}_{13} & {B}_{23} & {B}_{33}\end{matrix} ] \\ = [ \begin{matrix}\frac{1}{{α}^{2}} & - \frac{γ}{{α}^{2} β} & \frac{{v}_{0} γ - {u}_{0} β}{{α}^{2} β} \\ - \frac{γ}{{α}^{2} β} & \frac{{γ}^{2}}{{α}^{2} {β}^{2}} + \frac{1}{{β}^{2}} & - \frac{γ ( {v}_{0} γ - {u}_{0} β )}{{α}^{2} {β}^{2}} - \frac{{v}_{0}}{{β}^{2}} \\ \frac{{v}_{0} γ - {u}_{0} β}{{α}^{2} β} & - \frac{γ ( {v}_{0} γ - {u}_{0} β )}{{α}^{2} {β}^{2}} - \frac{{v}_{0}}{{β}^{2}} & \frac{{( {v}_{0} γ - {u}_{0} β )}^{2}}{{α}^{2} {β}^{2}} + \frac{{v}_{0}^{2}}{{β}^{2}} + 1\end{matrix} ]\end{matrix} \qquad ( 7 )$$

It is noted B is symmetric and thus can be represented by a 6D vector b:
b=[B₁₁ B₁₂ B₂₂ B₁₃ B₂₃ B₃₃]^{T} (8)
Let the ith column vector of H be hᵢ=[hᵢ₁ hᵢ₂ hᵢ₃]^{T}, then
hᵢ^{T}Bhᵢⱼ=vᵢⱼ^{T}b (9)
where
vᵢⱼ=└hᵢ₁hⱼ₁ hᵢ₁hⱼ₂+hᵢ₂hⱼ₁ hᵢ₂hⱼ₂ hᵢ₃hⱼ₁+hᵢ₁hⱼ₃ hᵢ₃hⱼ₂+hᵢ₂hⱼ₃ hᵢ₃hⱼ₃┘
And the following equation is obtained:

$$[ \begin{matrix}{v}_{12}^{T} \\ {( {v}_{11} - {v}_{22} )}^{T}\end{matrix} ] b = 0 \qquad ( 10 )$$

Since b has six unknowns and since the value of b is scale factor related, when the number of the images (n) taken by the camera is greater than three, a closed form solution for b can be obtained. With b obtained, the intrinsic parameters can be calculated as follows:
v₀=(B₁₂B₁₃−B₁₁B₂₃)/(B₁₁B₂₂−B₁₂²)
λ=B₃₃−[B₁₃²+v₀(B₁₂B₁₃−B₁₁B₂₃)]/B₁₁
α=\sqrt{λ/B₁₁} (11)
β=\sqrt{λB₁₁/(B₁₁B₂₂−B₁₂²)}
γ=−B₁₂α²β/λ
u₀=γv₀/β−B₁₃α²/γ
When given n images of a model plane and there are m points on the model plane, the maximum likelihood estimate can be obtained by minimizing the following equation:

$${\sum }_{i = 1}^{n} {\sum }_{j = 1}^{m} {‖ {m}_{i j} - \hat{m} ( A , {R}_{i} , {t}_{i} , {M}_{j} ) ‖}^{2} \qquad ( 12 )$$

Once the intrinsic parameters A are known, Church's method or Arun's method can be employed to formulate the transformation of coordinates between different cameras.

However, the conventional technique requires many cameras to simultaneously observe the calibration object, which needs the calibration object to be fixed, whereby the calibration object cannot be large or is not easy to move around.

The most related method is the one proposed by Peter F. Sturm and Long Quan, see “Camera Calibration and Relative Pose Estimation from Gravity,” International Conference on Pattern Recognition, Barcelona, Spain, Vol. 1, No. 1, September 2000, pp. 72-75. The method proposed by Sturm and Quan first estimates the infinite homography by using corresponding vanishing points and lines and then obtains intrinsic parameters and relative pose from the estimated infinite homography. Instead of estimating infinite homography, the method in accordance with the present invention first estimates the homography between image plane and trajectory plane, and then uses the constraints provided by the homography to compute intrinsic and extrinsic parameters of the camera. The difference between homography and infinite homography is as follows: Considering two sets of coplanar features in two planes. The relationship between the two sets of features is a homography. If the 3D features considered are located on the plane at infinity, the associated homography between the planes is often referred to as an infinite homography. For those interested in infinite homography, the following articles may be consulted: O. Faugeras, “Stratification of Three-Dimensional Vision. Projective, Affine, and Metric Representations,” Journal of the Optical Society of America A, Vol. 12, No. 3, March 1995, pp. 465-484.

Further, the method of the present invention is more flexible in the following aspects. First, the method of the present invention can be applied even if there is only one camera, while Sturm and Quan's method needs to use at least two cameras. Second, the method of the present invention can be used to estimate all the intrinsic parameters, while Sturm and Quan's method can estimate only a subset of the intrinsic parameters due to the insufficient constraints provided by the infinite homography. Third, Sturm and Quan's method suffers from the singularity problem when the optical axes of the two cameras are parallel, while the present invention does not have this problem and is therefore more flexible.

### SUMMARY OF THE INVENTION

The present invention is aimed to provide a method for calibrating camera parameters, which effectively address the problems of the known methods, by carrying out calibration on camera by taking pictures of a moving object that is subject to the action of gravity. In accordance with the present invention, a moving object is caused to move along a trajectory that is formed under the influence of gravity. The trajectory is defined in a global coordinate system. A camera that is set to predetermined shutter speed continuously takes pictures of the moving object along the trajectory, forming a plurality of calibration images of which the coordinates in the camera and times when the images are taken are known. Given such images of known coordinates and image-taking times, the intrinsic parameters and extrinsic parameters of the camera can be obtained from the operation of equations of perspective projection geometry.

The present invention will be apparent to those skilled in the art by reading the following description of the best mode for carrying out the present invention, with reference to the attached drawings, in which:

### BRIEF DESCRIPTION OF THE DRAWINGS

FIG. 1 is a flowchart illustrating a method for calibrating camera parameters in accordance with the present invention;

FIG. 2 schematically shows how a parabolic trajectory of a moving object is formed by combining images consecutively taken by a camera; and

FIG. 3 is schematic view illustrating the operation of carrying out the method in accordance with the present invention.

### DETAILED DESCRIPTION OF THE BEST MODE FOR CARRYING OUT THE PRESENT INVENTION

Due to the influence caused by gravity, which exists everywhere and has a constant magnitude and constant direction, an object, which is also referred to as calibration object hereinafter, moving in the gravitational field exhibits particular physical properties. A method for calibrating camera parameter in accordance with the present invention carries out calibration on camera parameters on the basis of the moving object of which the movement is subject to the influence of the gravity.

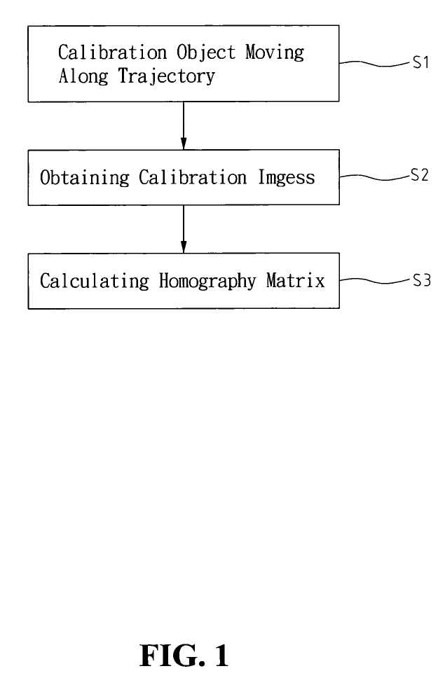

With reference to FIG. 1, a flow chart of the method in accordance with the present invention is illustrated. The method comprises three steps, which are used to obtain the intrinsic and extrinsic parameters of a camera. These steps includes a first step, step S1, in which an object is caused to move along a trajectory; a second step, step S2, in which the moving object is repeatedly pictured to obtain a plurality of calibration images; and a third step, step S3, in which the intrinsic and extrinsic parameters of the camera are derived with equations of perspective projection geometry. Preferably, an electronic stroboscope is employed to reduce motion blur in taking pictures of the moving object.

There are many movements that are caused by gravity. For simplification of description, the most commonly known free falling trajectory and parabolic trajectory are used as examples in the following description. Other movements or trajectories that are caused by gravity can also be employed to obtain the homography matrix with the well-known equations of perspective projection geometry, which can be further employed to obtain the intrinsic and extrinsic parameters of camera.

If an object is released from a still condition, the moving trajectory is a vertical line. For the object moving along a vertical line, the position of the object in the global coordinate system can be represented as gT²/2 in Y-axis coordinate, while the coordinates in X- and Z-axis remain fixed. If an object is thrown away at a specific angle, the moving trajectory exhibits a parabolic curve. The position coordinates of the object in the global coordinate system are vT in X-axis, and gT/²/2 in Y-axis, while the coordinate in Z-axis is fixed. Symbol v is velocity of the moving object, g is gravity, and T is time.

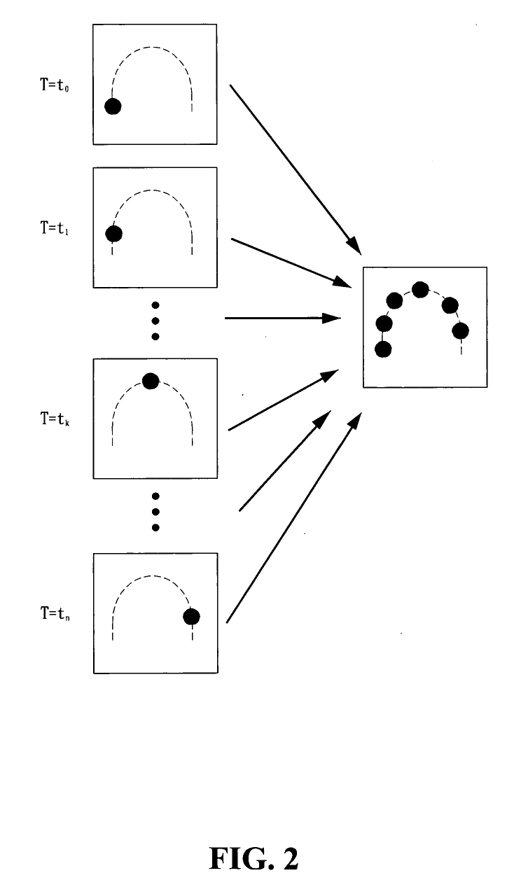

Also referring to FIG. 2, which shows a plurality of picture frames that are consecutively taken for the object moving along a given trajectory, constituting the calibration images of step 2 of the present invention, the moving object that moves along a give trajectory, which in the example is a ball moving along a parabolic curve, is repeatedly pictured and a plurality of images is sequentially taken. By composing these sequentially taken images together, the parabolic trajectory along which the object moves is formed. The trajectory that is so formed by composing the sequentially taken images is used to carry out calibration of the intrinsic parameters and extrinsic parameters of the camera that takes the images.

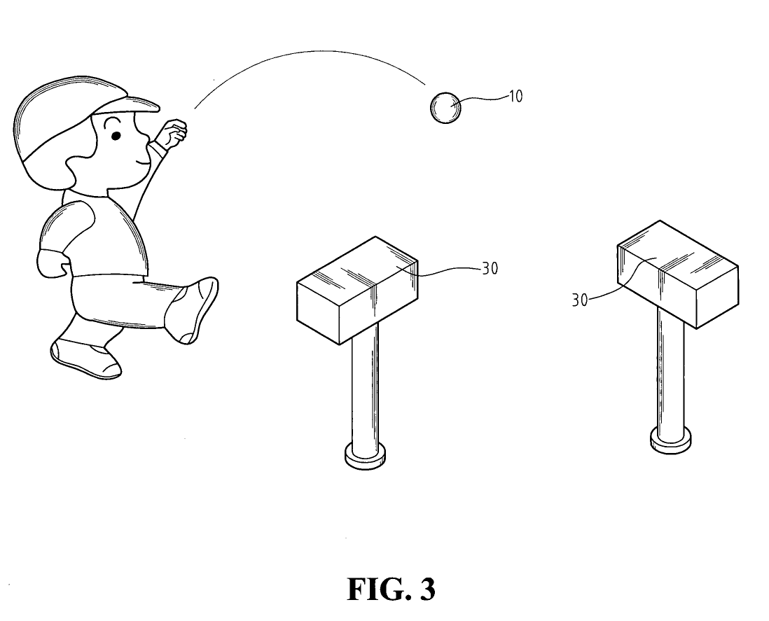

Also referring to FIG. 3, which schematically shows the operation of the present invention, to calibrate cameras, which are designated with reference numeral 30, a ball 10 is thrown upward. The ball 10 is subject to deceleration induced by gravity and, once reaching the highest point, begins to fall. It is noted that any object that maintains rigidity during movement along a trajectory can be used to replace the ball 10.

The camera 30, under preset shutter speed, continuously takes pictures of the ball 10, obtaining a plurality of calibration images that are taken at specific times and are of specific coordinates, (X, Y), in the camera coordinate system, such as an image taken at time Tₖ and of the camera coordinates corresponding the highest point of the parabolic trajectory.

By collecting sufficient number of calibration images, the homography matrix between the trajectory plane and the image plane of the camera 30 can be obtained by employing the equations of perspective projection geometry on the (X, Y) coordinates of the ball 10 in the camera coordinate system and the times when the images are taken.

Since the (X, Y) coordinates of each calibration image of the ball 10 in the camera coordinate system are known, and since the coordinate of the moving object 10 in the X-axis of the global coordinate system is vT, that in Y-axis is gT²/2, and that in Z-axis is fixed. Due to the fact that the shutter speed of the camera 30 is known, the times when the images are taken can be easily calculated. Thus, Y coordinate of the object in the global coordinate system can be computed easily. Although there may be no knowledge about the velocity v of the moving object, yet it is known that v is constant in each throw of the object. Accordingly, equation (2) is rewritten as follows:

$$s [ \begin{matrix}x \\ y \\ 1\end{matrix} ] = [ \begin{matrix}{h}_{1} & {h}_{2} & {h}_{3}\end{matrix} ] [ \begin{matrix}v t \\ Y \\ 1\end{matrix} ] \qquad ( 13 )$$

Since v is constant, equation (13) can be further rewritten as follows:

$$s [ \begin{matrix}x \\ y \\ 1\end{matrix} ] = [ \begin{matrix}v {h}_{1} & {h}_{2} & {h}_{3}\end{matrix} ] [ \begin{matrix}t \\ Y \\ 1\end{matrix} ] \qquad ( 14 )$$

By defining a parabolic transformation matrix H′ as follows:
H′=[vh₁ h₂ h₃]
then equation (14) is rewritten as follows:

$$s [ \begin{matrix}x \\ y \\ 1\end{matrix} ] = {H}^{′} [ \begin{matrix}t \\ Y \\ 1\end{matrix} ] \qquad ( 15 )$$

Since the variables x, y, t, Y are known, the matrix H′ can be calculated, if at least four images at four different positions along the trajectory are taken. Due to minor errors that occur in measurement, the more positions (x, y) are known, the better the solution will be. In this case that the coordinates of more than four positions are known, a maximum likelihood estimation of the homography matrix H′ can be obtained. Once the matrix H′ is known, the calculation of the intrinsic and extrinsic parameters can be done with known method, of which an illustration will be given in following.

From the above-discussed equations (5) and (6) and based on the fact that [h′₁ h′₂ h′₃]=[vh₁ h₂ h₃], the following equation can be obtained:

$${( \frac{{h}_{1}^{′}}{v} )}^{T} {A}^{- T} {A}^{- 1} ( \frac{{h}_{1}^{′}}{v} ) = {h}_{2}^{T} {A}^{- T} {A}^{- 1} {h}_{2} \qquad ( 16 )$$

and
h′₁^{T}A^{-T}A⁻¹h₂=0
Setting the ith column of the matrix H′ as h′ᵢ=[h′ᵢ₁ h′ᵢ₂ h′ᵢ₃ then equation (9) becomes:
h′^{T}ᵢBh′ⱼ=vᵢⱼ^{T}b (17)
where
vᵢⱼ=[h′ᵢ₁h′ⱼ₁ h′ᵢ₁h′ⱼ₂+h′ᵢ₂h′ⱼ₁ h′ᵢ₂h′ⱼ₂ h′ᵢ₃h′ⱼ₁+h′ᵢ₁h′ⱼ₃ h′ᵢ₃h′ⱼ₂+h′ᵢ₂h′ⱼ₃ h′ᵢ₃h′ⱼ₃]
and further from equation (16), the following equation can be obtained:
v₁₂^{T}b=0 (18)
The array b contains six variables, but the values of the variables of b are in proportion. Thus, a plurality of calibration images taken by throwing the calibration object 10 at least five times must be provided. For each throw, one homography matrix H′ is obtained and a set of corresponding vᵢⱼ can be calculated. When the total number of throws is great than five, sufficient number of sets of equation (18) is obtained and b can be solved. Based on the solution of b, the intrinsic parameters can be calculated. Due to the minor errors that often occur in doing measurement, more precise solution can be obtained with equation (12) of the maximum likelihood estimation based on more data collected from more times of throws.

Once the intrinsic parameters A are known, the horizontal velocity v of the calibration object in each throw can be calculated from equation (16). Once v is known, the coordinates X, Y are known and the trajectory of the calibration object in the throw can be calculated. Based on the knowledge of the trajectory, the above process can be repeated to correct the previously selected points. And better solution can be obtained.

As to the extrinsic parameters, only one throw is sufficient for calibration. Still, the more throws are done, the more precise solution that the maximum likelihood estimation can be obtained. When the intrinsic parameters, namely the matrix A, are known, equation (16) can be employed to calculate the horizontal velocity v of the parabolic trajectory, which is:

$${v}^{2} = \frac{{h}_{1}^{′T} {A}^{- T} {A}^{- 1} {h}_{1}^{′}}{{h}_{2}^{T} {A}^{- T} {A}^{- 1} {h}_{2}}$$

and the velocity v is:

$$v = \sqrt{\frac{{h}_{1}^{′T} {A}^{- T} {A}^{- 1} {h}_{1}^{′}}{{h}_{2}^{′} {A}^{- T} {A}^{- 1} {h}_{2}}} \qquad ( 19 )$$

The coordinates (X, Y) can then be computed. The distance between any two points along the trajectory can also be known. By selecting three points along the trajectory, Church's method can be employed to obtain 3D coordinates for image coordinates of the cameras, and then the transformation matrix [R|T] between the image coordinates of two cameras can be obtained by means of Arun's method. For those interested in Church's method and Arun's method, the following articles may be consulted: (1) E. Church, “Revised Geometry of the Aerial Photograph”, Bulletin of Aerial Photogrammetry, No. 15, 1945, and (2) K. S. Arun, T. S. Huang, and S. D. Blostein, “Least-Squares Fitting of Two 3D Point Sets”, IEEE Transactions on Pattern Analysis and Machine Intelligence, Vol. 9, No. 5, September 1987, pp. 698-700.

To this point, it is obvious that only a small ball caused to move in the gravitational field is sufficient for calibration of the parameters of cameras. The trajectory along which a small calibration object travels can be sized as desired. Thus, calibration can be done easily and efficiently.

Although the present invention has been described with reference to the best modes for carrying out the present invention, it is apparent to those skilled in the art that a variety of modifications and changes may be made without departing from the scope of the present invention which is intended to be defined by the appended claims.

What is claimed is:

1. A method for calibrating camera parameters on the basis of a moving calibration object subject to influence of gravity, comprising the following steps:
(a) causing the calibration object to move along a trajectory that is formed on a plane under the influence of gravity in a global coordinate system;
(b) consecutively taking pictures of the calibration object moving along the trajectory with a single camera having a preset shutter speed to obtain a plurality of calibration image with the calibration object at different positions having image coordinates in an image coordinate system and different times;
(c) based on the image coordinates of the positions of the captured calibration objects and the picturing times, estimating homography between image plane and trajectory plane; and
(d) using the constraints provided by the homography to obtain intrinsic and extrinsic parameters of the camera.

2. The method as claimed in claim 1, wherein the trajectory of the calibration object comprises a parabolic curve formed by throwing the calibration object at a preset angle.

3. The method as claimed in claim 2, wherein the coordinates of the calibration object in the global coordinate system comprises an X-axis coordinate, which is equal to velocity of the calibration object multiplied by time, a Y-axis coordinate which is equal to gravity multiplied by square of time and then divided by two, and a Z-axis coordinate that is constant.

4. The method as claimed in claim 1, wherein the trajectory of the calibration object comprises a vertical line that is formed by the calibration object released from still condition.

5. The method as claimed in claim 4, wherein the coordinates of the calibration object in the global coordinate system comprises an X-axis coordinate, which is constant, a Y-axis coordinate which is equal to gravity multiplied by square of time and then divided by two, and a Z-axis coordinate that is constant.

6. The method as claimed in claim 3, wherein the velocity is constant and wherein the X-axis coordinates is represented by time, a homography matrix between the image plane and the parabolic trajectory plane being estimated.

7. The method as claimed in claim 1, wherein the trajectory is formed by throwing the calibration object and wherein the calibration images of the calibration object are obtained by capturing the calibration object a plurality of times.

8. The method as claimed in claim 1 further comprising a step of using an electronic stroboscope to reduce motion blur effect in consecutively taking pictures of the calibration object moving along the trajectory.

9. The method as claimed in claim 1, wherein the calibration object comprises a spherical ball.

10. The method as claimed in claim 1, wherein the calibration object comprises an object that maintains rigidity when moving along the trajectory.
